(19) United States
(12) Patent Application Publication
(10) Pub. No.: US 2026/0050998 A1
(43) Pub. Date: Feb. 19, 2026

(54) Agriculture Lien Management System

(71) Applicant: Bushel Inc., Fargo, ND (US)

(72) Inventors: Damon Larson, Fargo, ND (US); Ryan Raguse, Fargo, ND (US)

(21) Appl. No.: 19/292,593

(22) Filed: Aug. 6, 2025

Related U.S. Application Data
(60) Provisional application No. 63/684,858, filed on Aug. 19, 2024.

(51) Int. Cl. G06Q 50/02; G06Q 20/36; G06Q 40/03

(52) U.S. Cl. CPC G06Q 50/02; G06Q 20/36; G06Q 40/034; G06Q 40/039

(57) ABSTRACT

A processor implemented method for agricultural lien management includes setting up an electronic wallet interface in an agricultural lien management system for a user associating the user with a particular lien; receiving an agricultural delivery from the user at an agricultural facility; sending a notice from the agricultural lien management system to a lender that the user has delivered the agricultural product to the agricultural facility and the agricultural product is bound by the particular lien, the agricultural facility obligated to make a payment for the agricultural product; receiving a directive from the lender to distribute the payment between the user and the lender in response to the notice; and sending instructions from the agricultural lien management system to the electronic wallet interface on where to send the payment in response to the directive from the lender.

### CROSS REFERENCE TO RELATED APPLICATION [S]

The present disclosure claims priority to United States Provisional Patent Disclosure Ser. No. 63/684,858 filed Aug. 19, 2024. Each of the aforementioned patent applications, and any applications related thereto, are herein incorporated by reference in their entirety.

### BACKGROUND

The present disclosure relates generally to a cloud-based Software as a Service. Specifically, it relates to agriculture lien management between three parties (Grower [e.g., seller], Financial Institution [e.g., lender], and AgriBusiness [e.g., buyer]). The agriculture lien management system stores agriculture liens based in all 50 United States allowing for creation, searching, releasing, and payments in relationship to said liens.

When a user (e.g., farmer) obtains a loan at the beginning of the year, some lenders may file a UCC chattel lien. The grain the user is growing is secured and any money made off growing that grain has to be tied back to a particular lender (e.g., lien). At the end of harvest, the farmer is ready for settlement payment. Onus is on the grain facility (e.g., payer) to figure out through state records or from notices received from the farmer or lender whether or not the farmer has a lien from this specific yield to determine if they must make out a check payable to both the farmer and the lien holder. A grain facility may as an example be a grain elevator.

Current manual processes for lien management and payment are inadequate and the grain facility may be exposed to unnecessary risk. In each instance, the buyer of the commodity is required to check a system or multiple systems for a lien against a seller. If the buyer pays a seller and there was a lien present, the buyer may be liable to the lien holder for the payment made. In addition to the extra risk, there currently is no digital lien management option available to buyers of agricultural commodities as current processes typically require labor intensive paper processes.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1A is a schematic view of a system for an agricultural lien management system according to one disclosed non-limiting embodiment.

FIG. 1B is a schematic view showing operation of the agricultural lien management system according to one disclosed non-limiting embodiment.

FIG. 1C-1E is a schematic view of a workflow showing operation of the agricultural lien management system according to one disclosed non-limiting embodiment.

FIG. 1F is a chart illustrating actions of the agricultural lien management system according to one disclosed non-limiting embodiment.

FIG. 1G is a schematic view of parties/artifacts relationship within the agricultural lien management system according to one disclosed non-limiting embodiment.

FIG. 2 is a schematic view of a network of the agricultural lien management system according to one disclosed non-limiting embodiment.

FIG. 3 is a flow chart of a user enrollment (buyer, seller, Lender) of an agricultural lien management system according to one disclosed non-limiting embodiment.

FIG. 4 is a flow chart of an import State CNS Flat Files of an agricultural lien management system according to one disclosed non-limiting embodiment.

FIG. 5 is a flow chart of a schematic view of a user who manually enters a lien due to being in a “Direct Notice State” or insufficient state system of an agricultural lien management system according to one disclosed non-limiting embodiment.

FIG. 6 is a flow chart of a lender who removes a lien that has been satisfied of an agricultural lien management system according to one disclosed non-limiting embodiment.

FIG. 7 is a flow chart of a lender who invites a borrower/seller/buyer, a buyer who invites a seller/lender, and a seller who invites buyer/lender of an agricultural lien management system according to one disclosed non-limiting embodiment.

FIG. 8 is a flow chart of a search for lien within the agricultural lien management system according to one disclosed non-limiting embodiment.

FIG. 9 is a flow chart of a decision request on a payment within the agricultural lien management system according to one disclosed non-limiting embodiment.

FIG. 10 is a flow chart of an approval for a decision request on a payment within the agricultural lien management system according to one disclosed non-limiting embodiment.

FIG. 11 is a flow chart of a payment decision within the agricultural lien management system according to one disclosed non-limiting embodiment.

FIG. 12 is a flow chart of a payment being made within the agricultural lien management system according to one disclosed non-limiting embodiment.

FIG. 13 is a flow chart of a lien release request within the agricultural lien management system according to one disclosed non-limiting embodiment.

FIG. 14A-14F is a chart of a lien portal specific to each state within the United States of an agricultural lien management system according to one disclosed non-limiting embodiment.

### SUMMARY

A processor implemented method for agricultural lien management according to one disclosed non-limiting embodiment of the present disclosure includes setting up an electronic wallet interface in an agricultural lien management system for a user associating the user with a particular lien; receiving an agricultural delivery from the user at an agricultural facility; sending a notice from the agricultural lien management system to a lender that the user has delivered the agricultural product to the agricultural facility and the agricultural product is bound by the particular lien, the agricultural facility obligated to make a payment for the agricultural product; receiving a directive from the lender to distribute the payment between the user and the lender in response to the notice; and sending instructions from the agricultural lien management system to the electronic wallet interface on where to send the payment in response to the directive from the lender.

A further embodiment of any of the foregoing embodiments of the present disclosure includes, wherein the agricultural product comprises grain.

A further embodiment of any of the foregoing embodiments of the present disclosure includes, wherein transferring the payment via the electronic wallet interface upon verifying availability of user funds.

A further embodiment of any of the foregoing embodiments of the present disclosure includes verifying the user of the electronic wallet interface via matching user provided data to the agricultural lien management system.

A further embodiment of any of the foregoing embodiments of the present disclosure includes determining a confidence score for the user within the agricultural lien management system.

A further embodiment of any of the foregoing embodiments of the present disclosure includes associating the user of the electronic wallet interface with a particular lien.

A further embodiment of any of the foregoing embodiments of the present disclosure includes associating the user with a particular lien comprises scanning UCC data via the agricultural lien management system.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### DETAILED DESCRIPTION

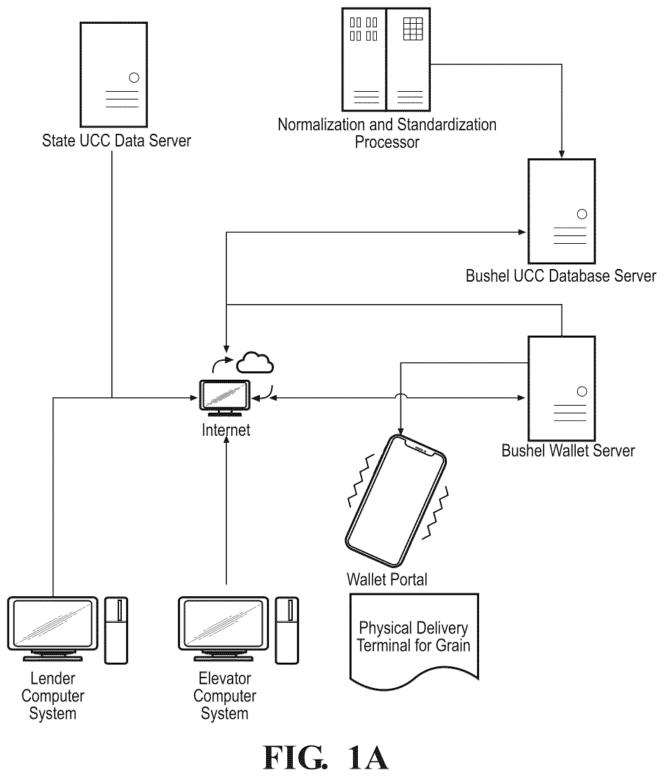

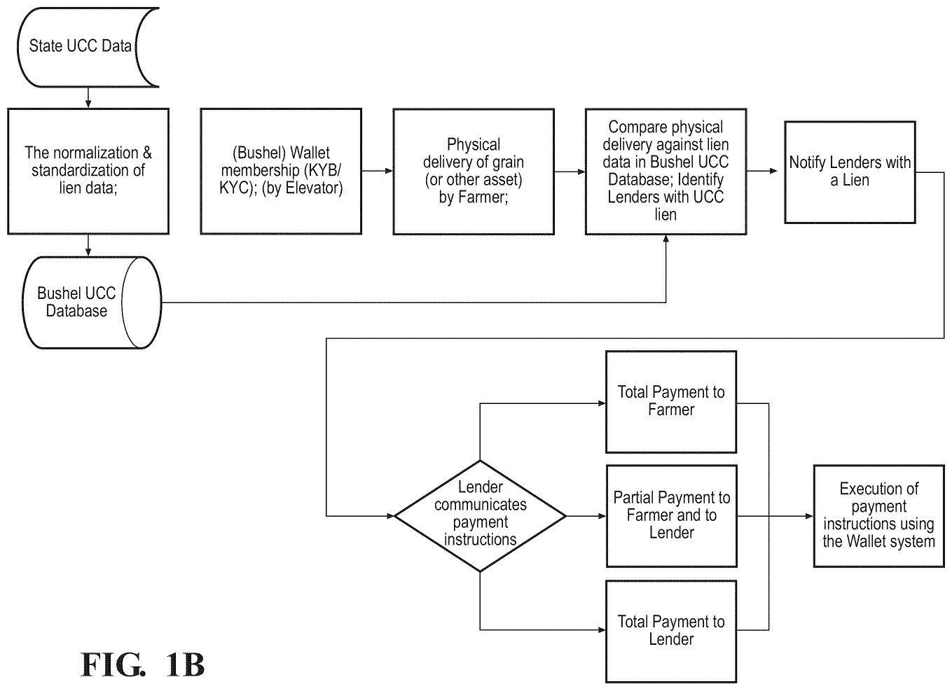

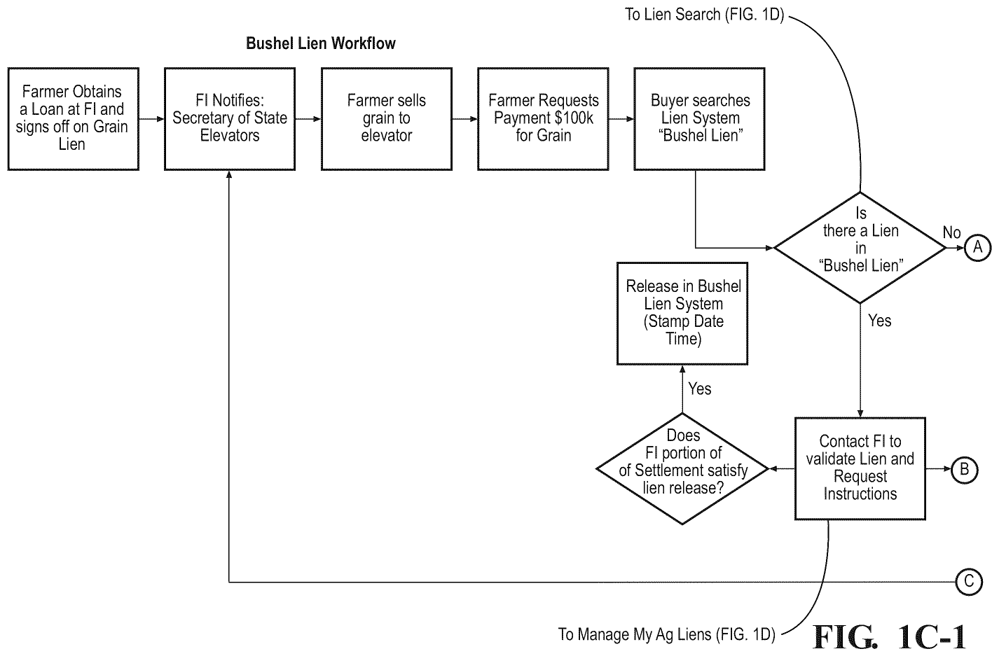

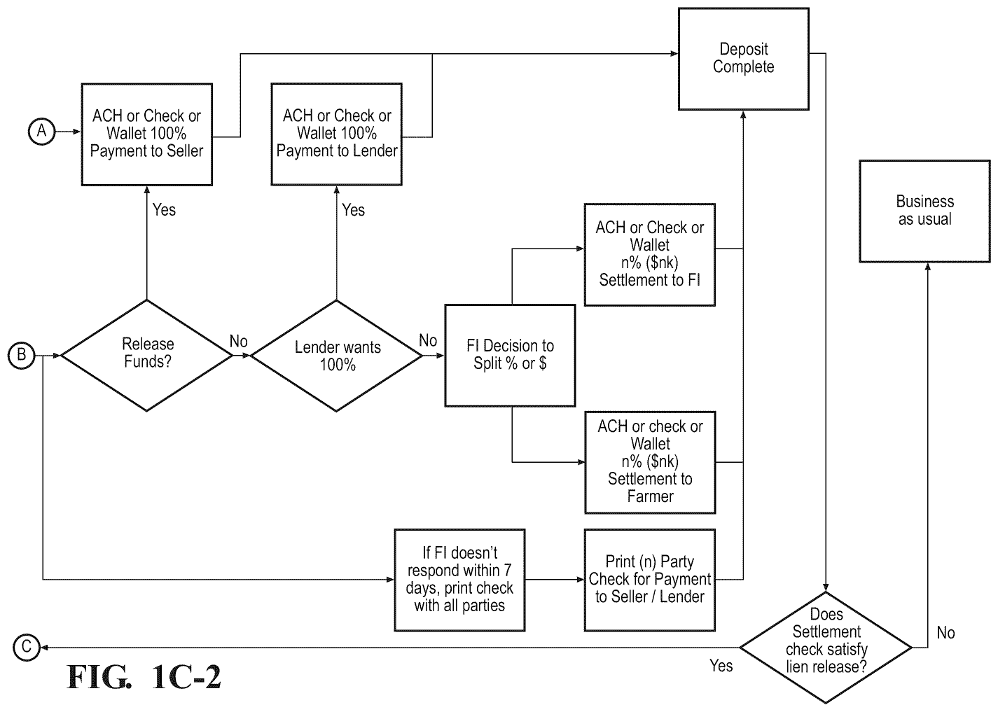

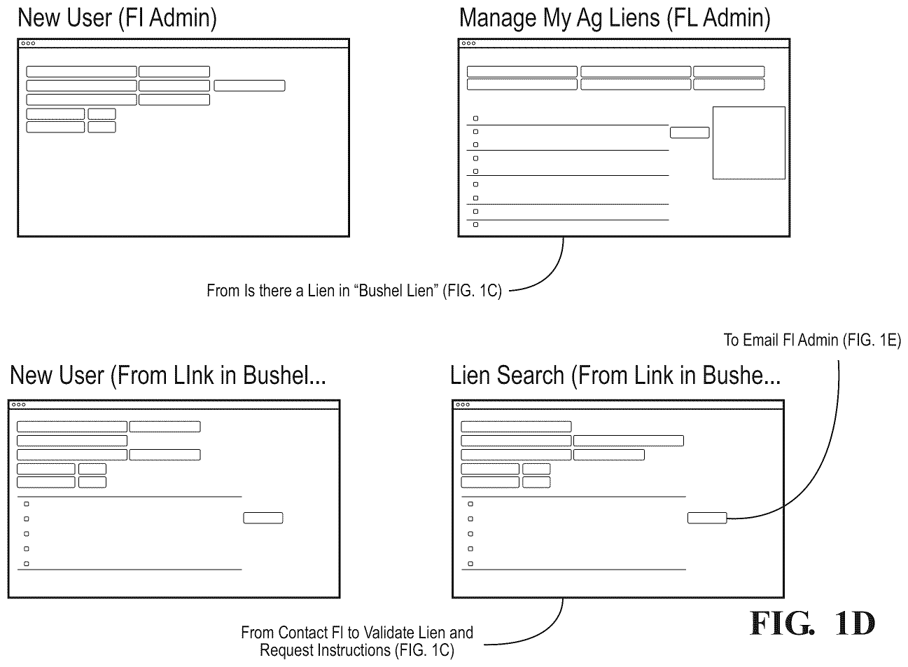

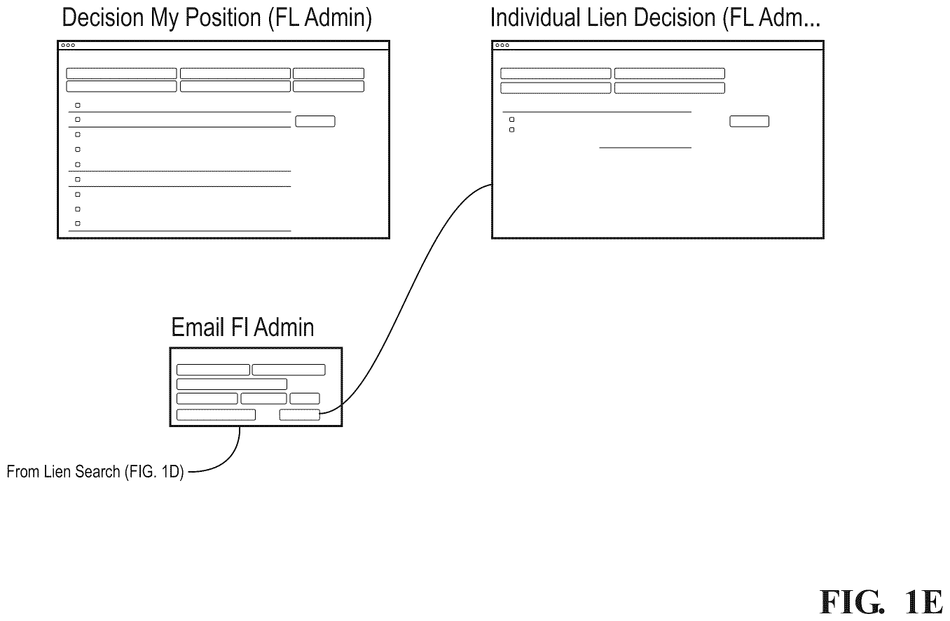

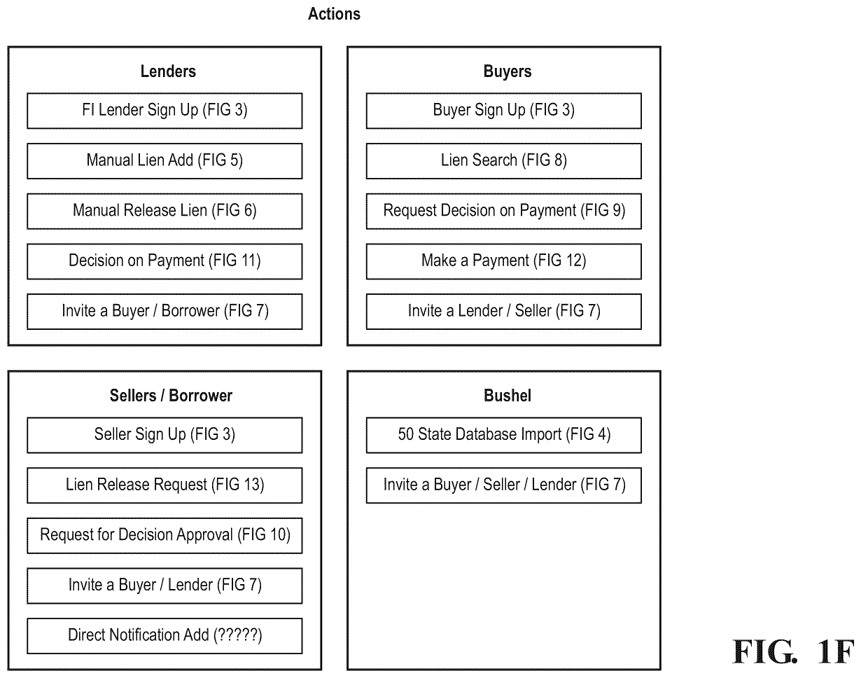

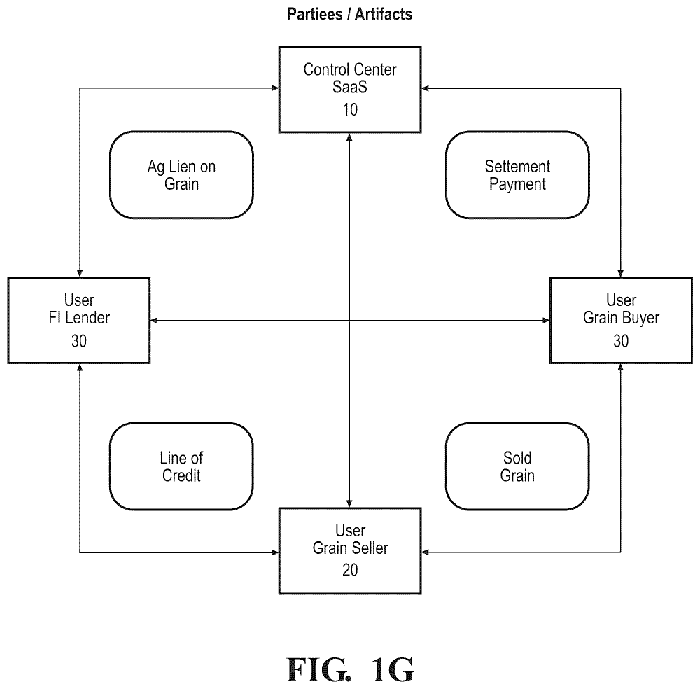

FIG. 1A-1E schematically illustrates an agricultural lien management system 200 that may be a module associated with, and or incorporated within, an agricultural credit tracking system for users such as farmers, ranchers, rural homeowners, aquatic producers, timber harvesters, agribusinesses, and agricultural and rural utility cooperatives, etc., as disclosed in U.S. patent application Ser. No. 18/662,407 (02183-BUS) and any applications related thereto, which are herein incorporated by reference in their entirety.

The agricultural lien management system 200 checks lien repositories automatically and offers digital management of liens within the payments process for agricultural commodity buyers. The agricultural lien management system 200 may operate (FIG. 1B) in accord with a workflow (FIG. 1C-1E).

The agricultural lien management system 200 may provide multiple activities (FIG. 1F and FIG. 3-13).

The lien management system 200 may be configured to receive imported lists of data. For example, a grain facility may import a list of customers so that the grain facility management may receive notifications on new liens or released liens related to a customer or user.

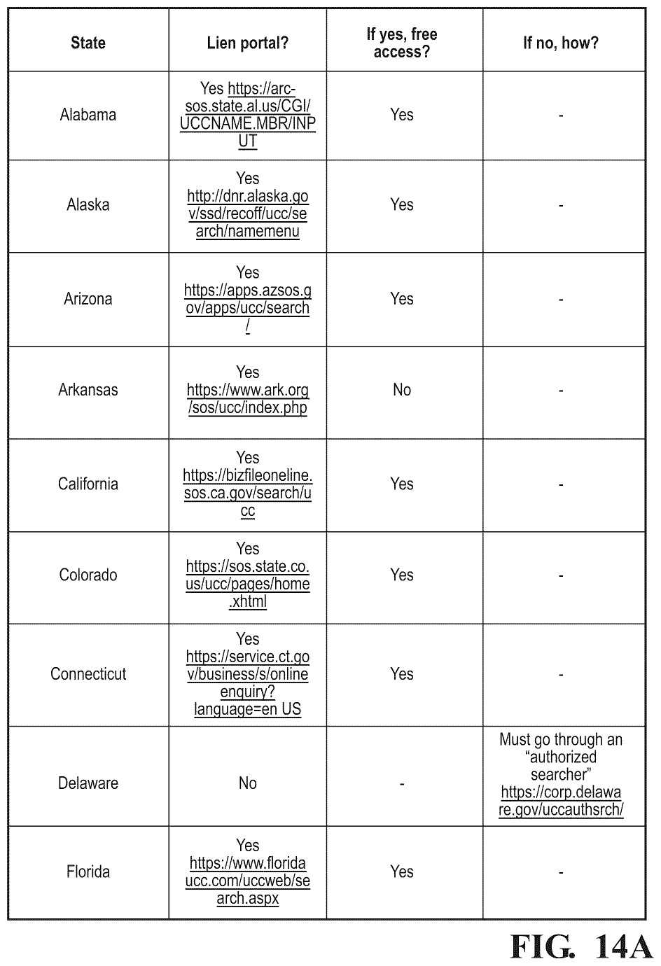

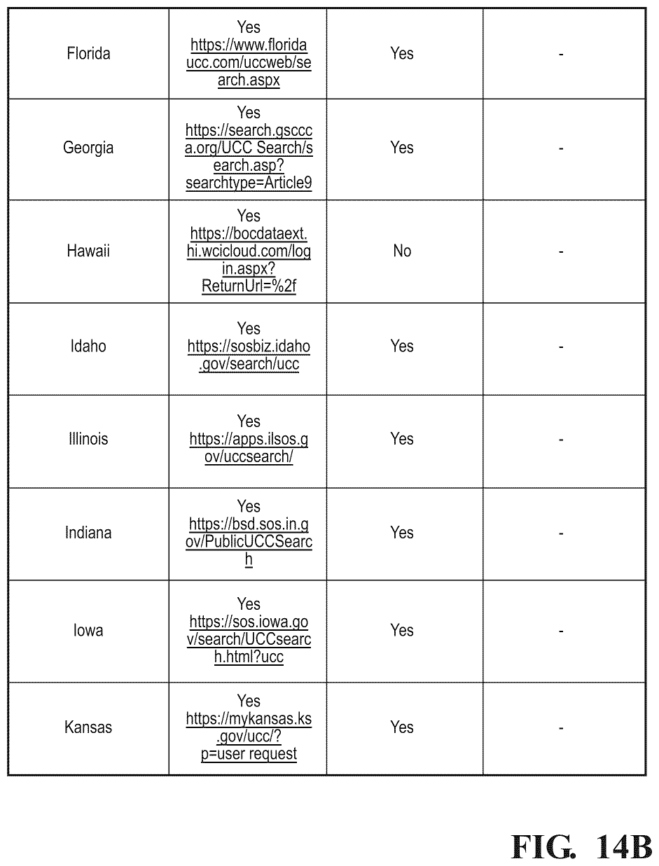

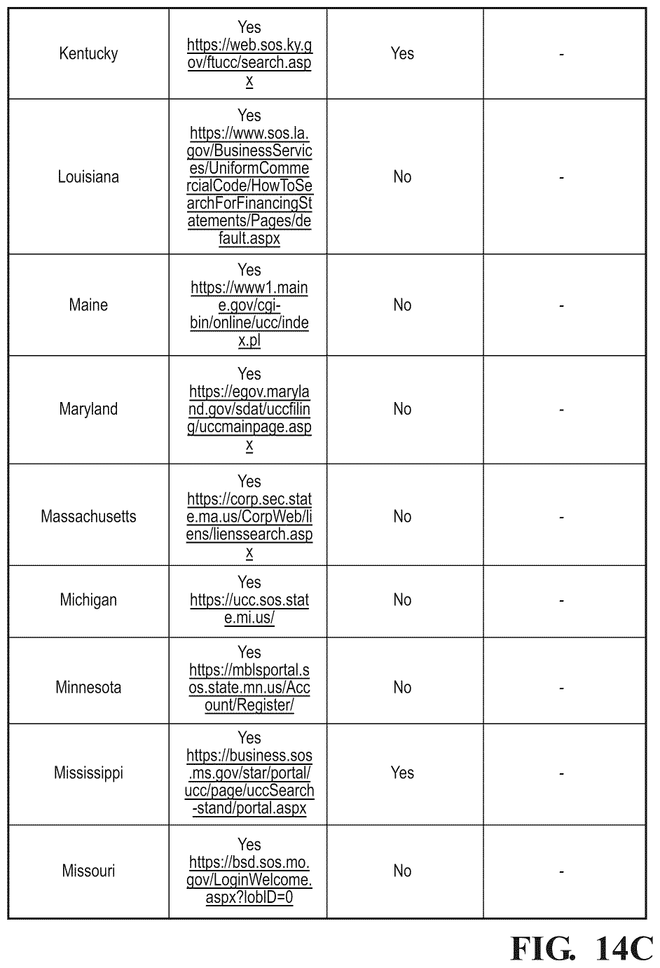

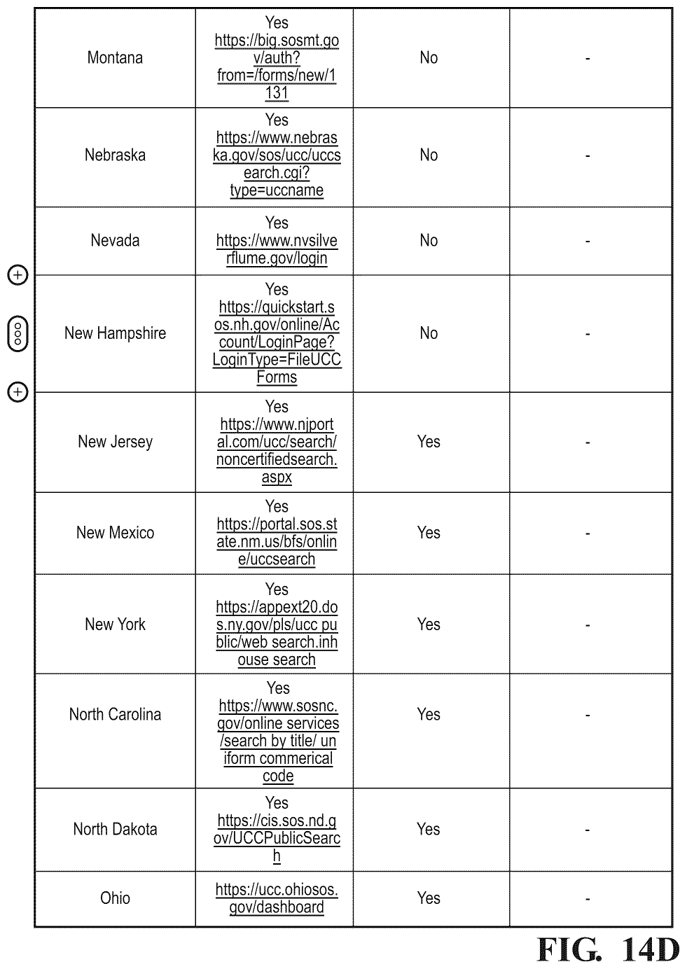

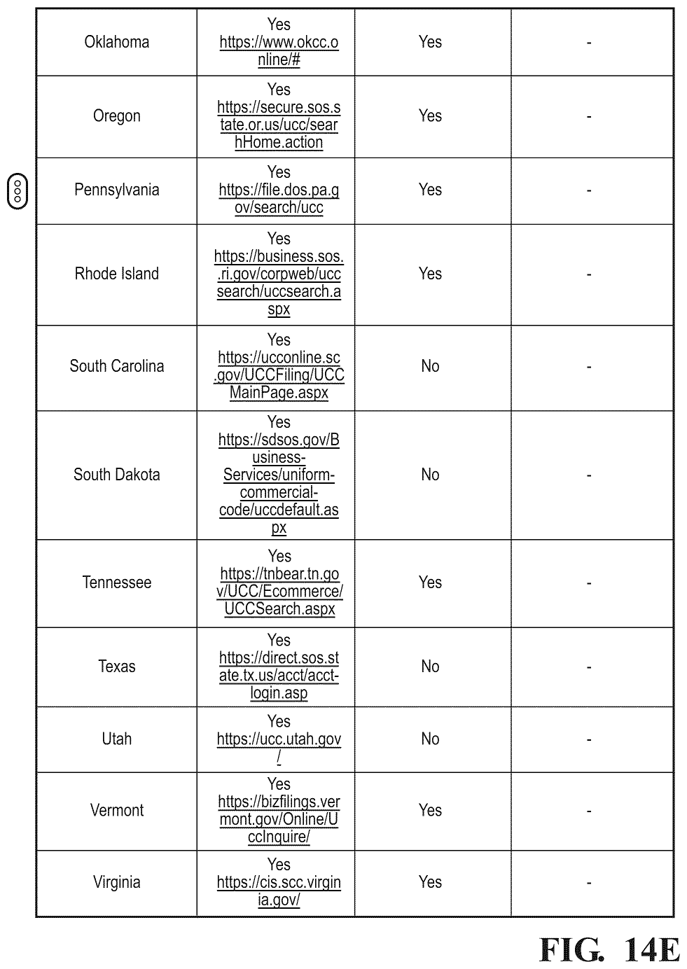

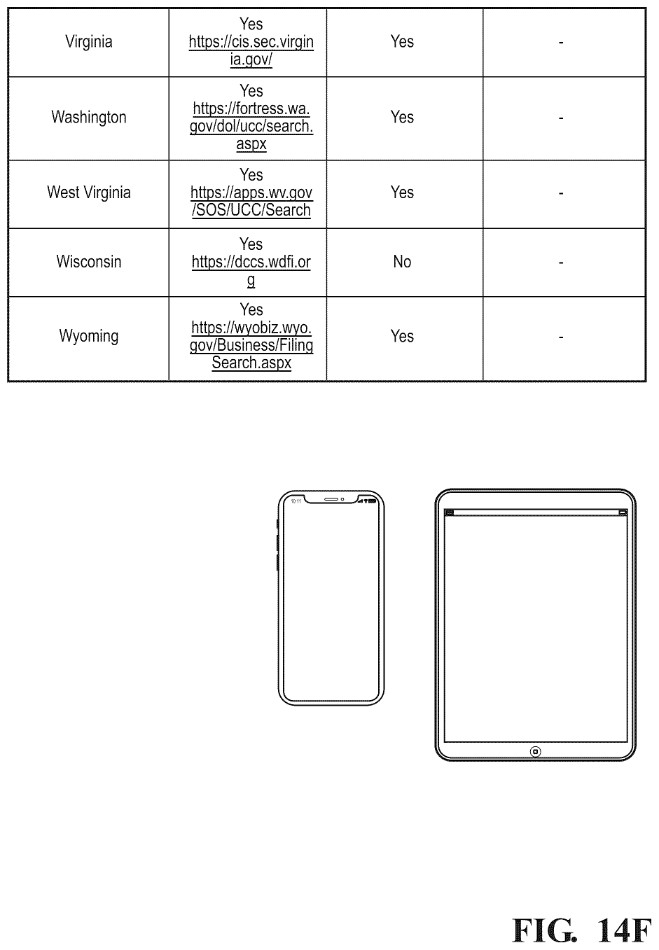

The agricultural lien management system 200 may be processor implemented (FIG. 1A). In one embodiment, an electronic wallet interface is set up within an agricultural credit tracking system for a user. The electronic wallet interface (i.e., Bushel Wallet), runs on a server (i.e., Bushel Platform) to operate as an interface with various states (e.g., each of the 50 states in the United States; FIG. 14A-14F) and a standardization and normalization server to address the various states which may each have particular characteristics. Standardization and normalization may include the extrapolation of data into a common unit.

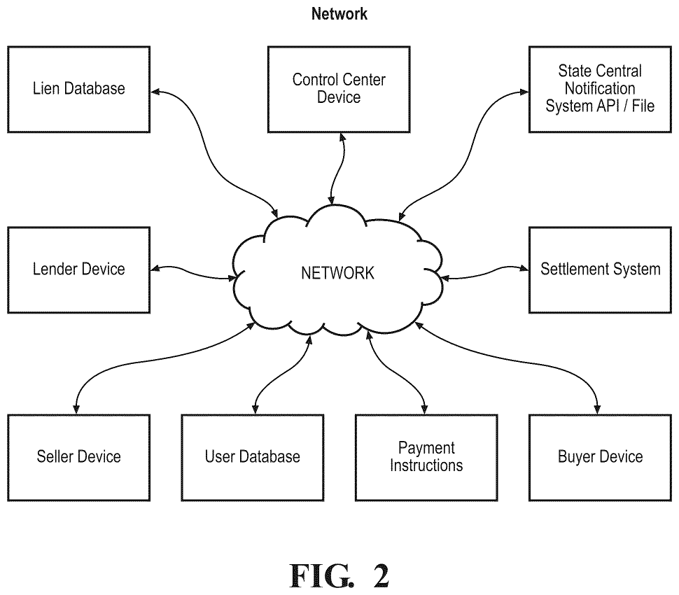

The server may include computing device hardware (e.g., servers, processors, processing devices, workstation, mainframes, network, etc.) and/or software that provide data and computation functionality services to programs, models, and devices via a request-response methodology. The server may include memory storing computer executable programs, such as the electronic wallet interface (i.e., Bushel Wallet), executed by one or more processors to implement the functionality described herein. The server may also include communications interfaces with external components. The term “server” conveys its customary meaning that provides service and/or data connection to, for example, the client-facing website, and/or the client-facing mobile app through a network such as the internet, or other such network (FIG. 2).

In an embodiment, the server may include one or more hardware processors, one or more memory devices, and a data repository. The memory devices may be in communication with the one or more hardware processors, wherein the one or more hardware processors are configured to execute programmed instructions stored in the memory devices to perform various functions as explained herein. The data repository may be an organized collection of data that includes database management systems that allow for manipulation of data through update and retrieval for use by the server.

The client-facing website may be a website published on a web server and available publicly via the internet. Alternatively, or in addition, the client-facing website may be configured to include private access to the particular clients, via, for example, a password protected section to communicate client input data. The client-facing mobile app may be a client facing mobile software application configured to communicate with the server to communicate client input data. The client-facing mobile app may be installed on the handheld device.

The server communicates with the client-facing website, and/or the client-facing mobile app through any desired method of communications, including, for example, an SMS, MMS, cellular, GSM, CDMA, Wi-Fi, Wi-Max, wireless transmission, the Internet, LAN, WAN, email, telephone, and any wired or wireless paths or combinations thereof. The term “handheld device” refers to a portable electronic device that is at least configured to send messages to, and/or receive messages from the listing recommendation server over a long-range wireless communication network, such as a SMS, wireless, or cellular network. Examples of handheld devices include, but are not limited to, a mobile phone, a tablet, a portable computer, etc.

The server runs the platform (i.e., Bushel Platform) and the electronic wallet interface (i.e., Bushel Wallet) to provide communication and data transfer with outside systems such as lender computer systems and grain facility computer systems through the internet or other communication platform.

The user of the electronic wallet interface is then verified and associated with a particular lien. Various information may be matched with user data provided to the server (i.e., Bushel Platform) to determine a confidence score for verification as disclosed in U.S. patent application Ser. No. 18/662,407 (02183-BUS) and any applications related thereto, which are herein incorporated by reference in their entirety. Various mathematical confidence algorithms may be utilized to determine the confidence score which may then be directly confirmed and/or manually verified such that the electronic wallet interface (i.e., Bushel Wallet) is setup and available to the user and the line of credit (LOC) is a linked funding source.

Once the grain or other such crop is received at a grain facility (e.g. elevator) and/or a settlement for payment is created, a notice from the agricultural lien management system 200 is sent to a lender that the user has delivered the grain to the grain facility, the grain bound by the particular lien and the grain facility obligated to make a payment for the grain, such that the lender receives a directive to articulate acceptable payment distribution methods to the user. The lender's directive to distribute by the agricultural lien management system 200 may follow various procedures and requirements particular to the lender and incorporated into the agricultural lien management system 200 for releasing loan funds to the borrower. For example, the directive to distribute may entail: loan sanction, verification, borrower request, conditions for disbursement, etc.

Instructions are then sent from the agricultural lien management system 200 to the electronic wallet interface as to where to send the payment, in whole or in part, in response to the directive from the lender. The agricultural lien management system operates to transfer verified funds via the electronic wallet interface (i.e., Bushel Wallet) that runs on the server (i.e., Bushel Platform) to operate as an interface between, for example, an EFT Service Provider (Instructions/Funds Transfers/Check Printing, demand deposit account (DDA) for the farmer), a funding source such as that associated with the Farm Credit System (FCS; which is not a bank, and utilizes a line of credit (LOC) based system), the lien holder, the agricultural, e.g., grain facility, Payee (seller/farmer/grower/producer), Payer Financial Institution (lender/banker/financial institution), Payer (buyer/AgriBusiness/grain facility), Lien Database (from states or manually from FI), User Database (lender, farmer, AgriBiz), etc.

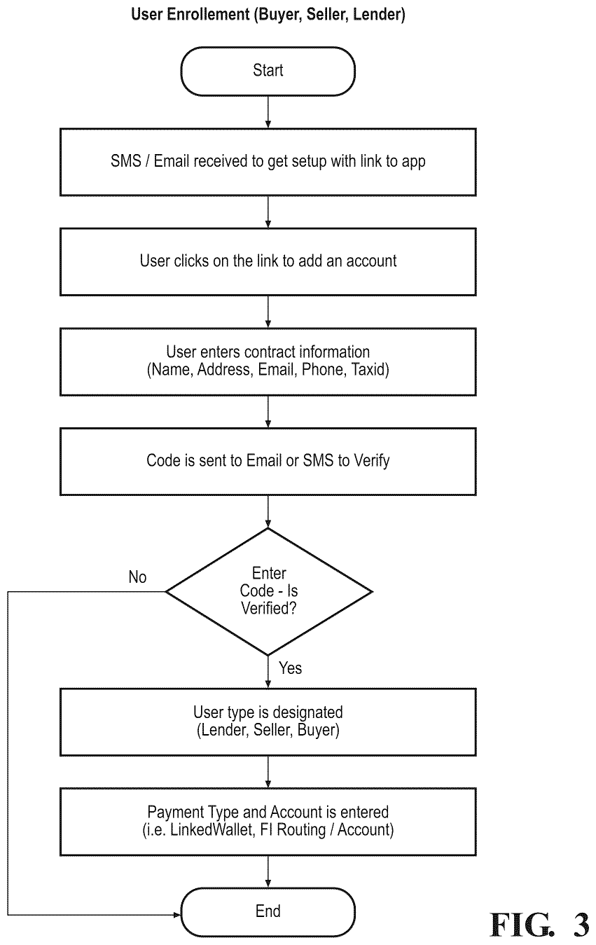

With reference to FIG. 3, a flow chart of a user enrollment (buyer, seller, Lender) of the agricultural lien management system 200 according to one disclosed non-limiting embodiment is schematically illustrated. The functions may be programmed software routines capable of execution in various microprocessor-based electronics control embodiments and are represented herein as block diagrams.

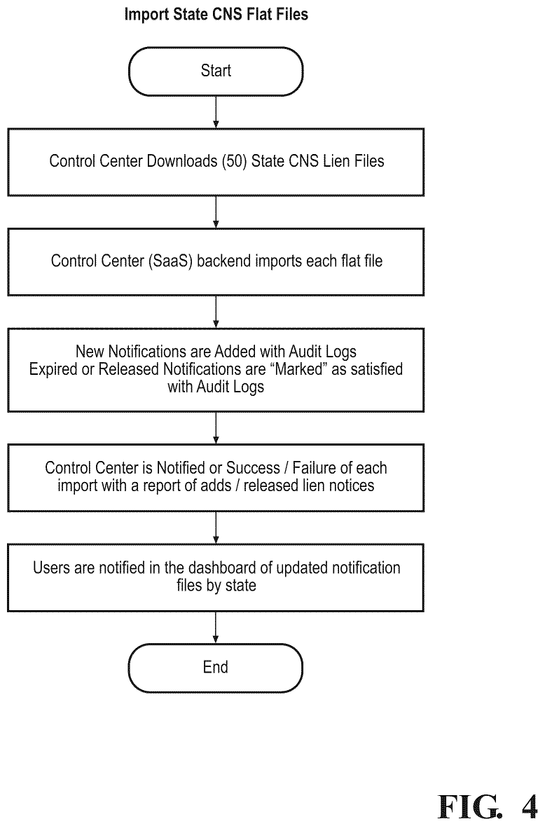

With reference to FIG. 4, a flow chart of an import of State CNS Flat Files into the agricultural lien management system 200 according to one disclosed non-limiting embodiment is schematically illustrated. The functions may be programmed software routines capable of execution in various microprocessor-based electronics control embodiments and are represented herein as block diagrams.

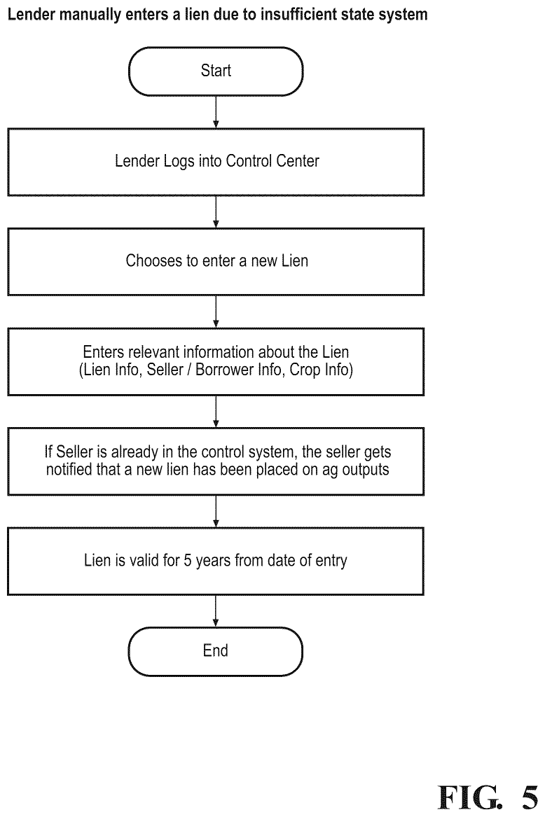

With reference to FIG. 5, a flow chart of a schematic view of a user (e.g., lender) who manually enters a lien due to being a “Direct Notice State” or insufficient state system of an agricultural lien management system according to one disclosed non-limiting embodiment is schematically illustrated. The functions may be programmed software routines capable of execution in various microprocessor-based electronics control embodiments and are represented herein as block diagrams.

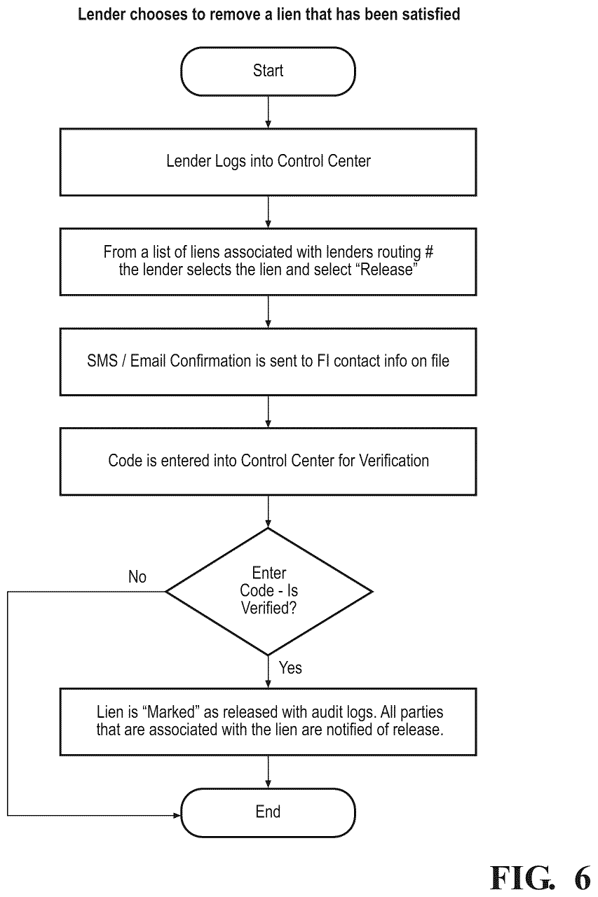

With reference to FIG. 6, a flow chart of a user (e.g., lender) who removes a lien that has been satisfied through the agricultural lien management system 200 according to one disclosed non-limiting embodiment is schematically illustrated. The functions may be programmed software routines capable of execution in various microprocessor-based electronics control embodiments and are represented herein as block diagrams.

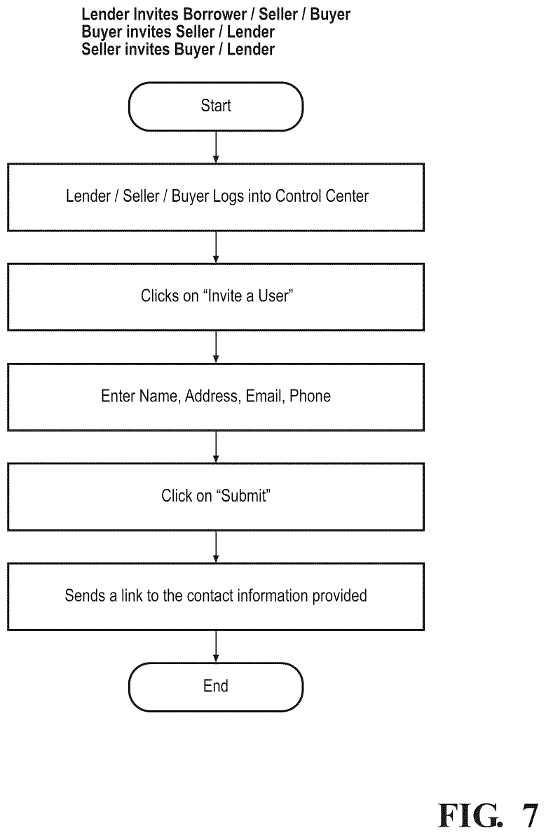

With reference to FIG. 7, a flow chart of a lender who invites a borrower/seller/buyer, a buyer who invites a seller/lender, and a seller who invites buyer/lender of the agricultural lien management system 200 according to one disclosed non-limiting embodiment is schematically illustrated. The functions may be programmed software routines capable of execution in various microprocessor-based electronics control embodiments and are represented herein as block diagrams.

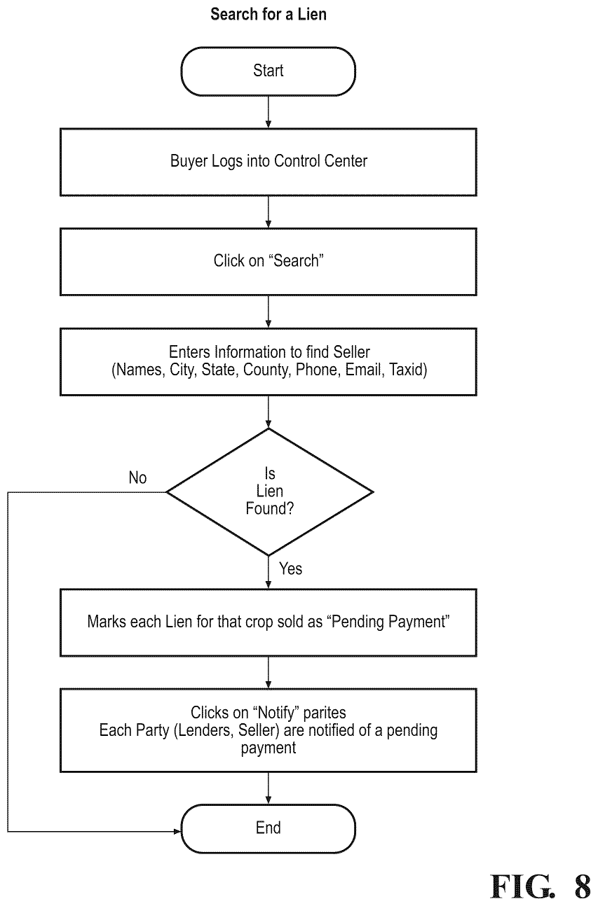

With reference to FIG. 8, a flow chart of a search for lien within the agricultural lien management system 200 according to one disclosed non-limiting embodiment is schematically illustrated. The functions may be programmed software routines capable of execution in various microprocessor-based electronics control embodiments and are represented herein as block diagrams.

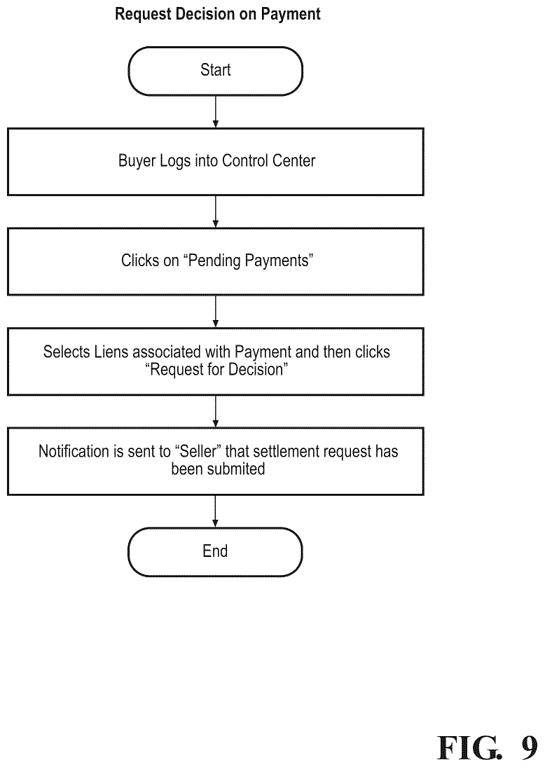

With reference to FIG. 9, a flow chart of a decision request on a payment within the agricultural lien management system 200 according to one disclosed non-limiting embodiment is schematically illustrated. The functions may be programmed software routines capable of execution in various microprocessor-based electronics control embodiments and are represented herein as block diagrams.

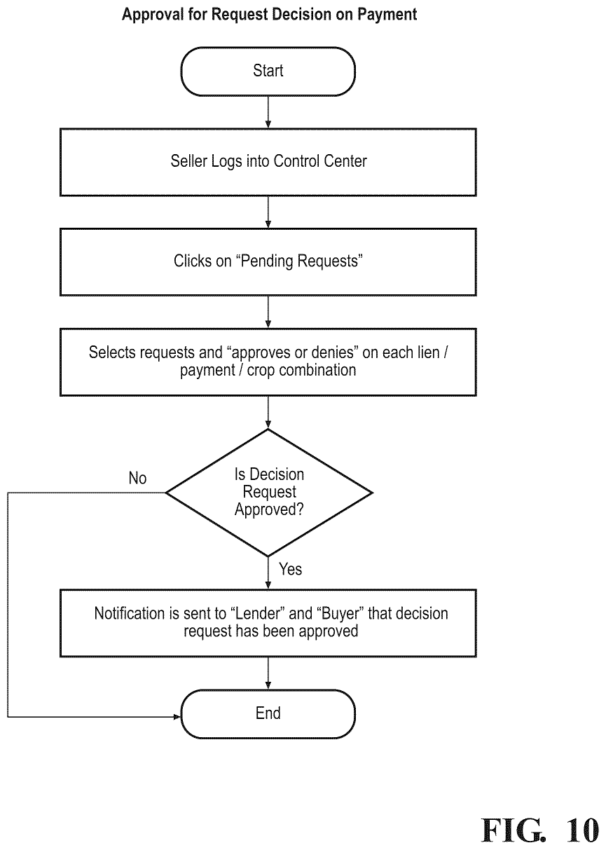

With reference to FIG. 10, a flow chart of an approval for a decision request on a payment within the agricultural lien management system 200 according to one disclosed non-limiting embodiment is schematically illustrated. The functions may be programmed software routines capable of execution in various microprocessor-based electronics control embodiments and are represented herein as block diagrams.

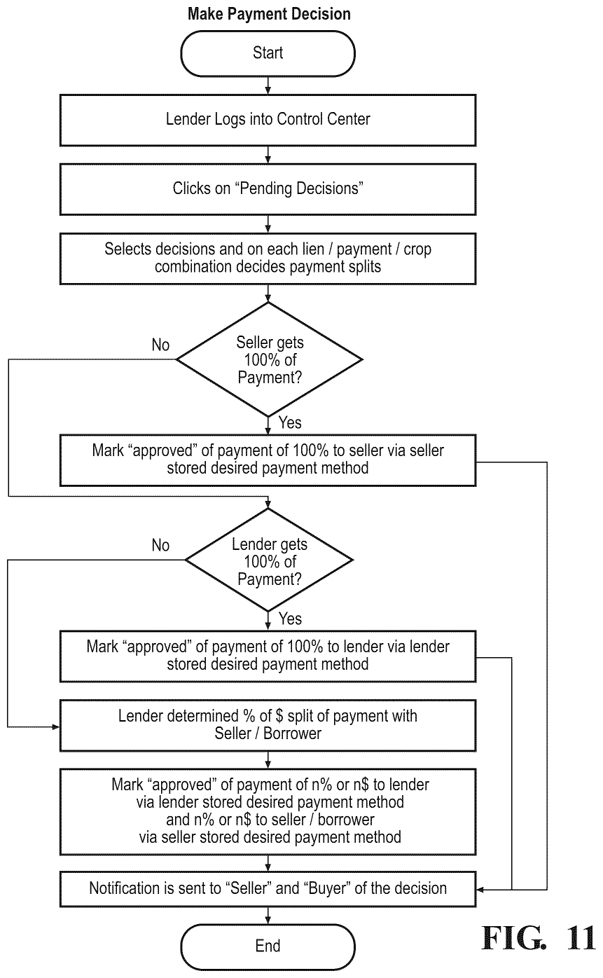

With reference to FIG. 11, a flow chart of a payment decision within the agricultural lien management system 200 according to one disclosed non-limiting embodiment is schematically illustrated. The functions may be programmed software routines capable of execution in various microprocessor-based electronics control embodiments and are represented herein as block diagrams.

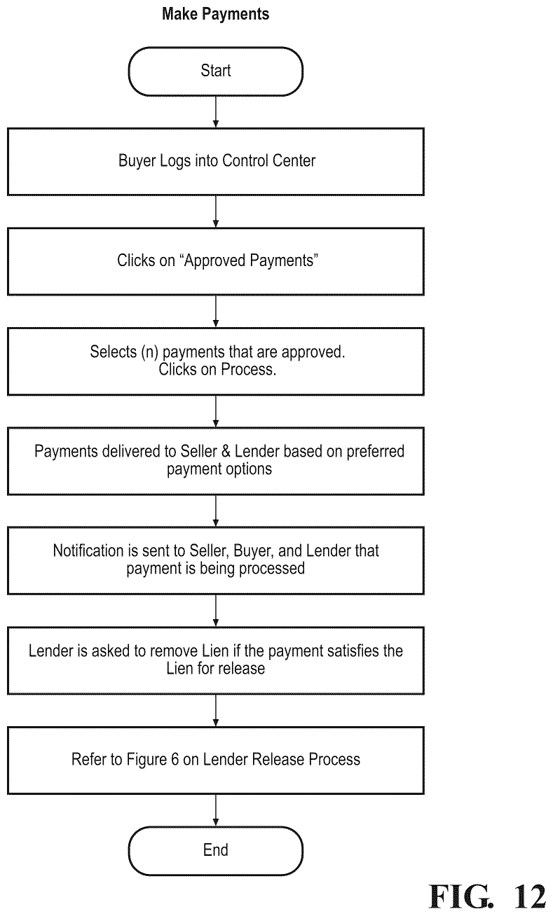

With reference to FIG. 12, a flow chart of a payment being made within the agricultural lien management system 200 according to one disclosed non-limiting embodiment is schematically illustrated. The functions may be programmed software routines capable of execution in various microprocessor-based electronics control embodiments and are represented herein as block diagrams.

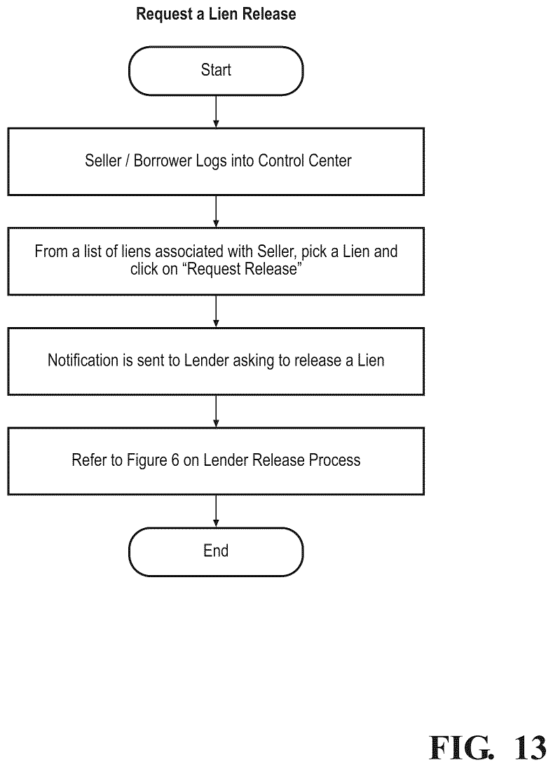

With reference to FIG. 13, a flow chart of a lien release request within the agricultural lien management system 200 according to one disclosed non-limiting embodiment is schematically illustrated. The functions may be programmed software routines capable of execution in various microprocessor-based electronics control embodiments and are represented herein as block diagrams.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason, the appended claims should be studied to determine true scope and content.

What is claimed:

1. A processor implemented method for agricultural lien management comprising:
setting up an electronic wallet interface in an agricultural lien management system for a user;
associating the user with a particular lien;
receiving an agricultural delivery from the user at an agricultural facility;
sending a notice from the agricultural lien management system to a lender that the user has delivered the agricultural product to the agricultural facility and the agricultural product is bound by the particular lien, the agricultural facility obligated to make a payment for the agricultural product;
receiving a directive from the lender to distribute the payment between the user and the lender in response to the notice; and
sending instructions from the agricultural lien management system to the electronic wallet interface on where to send the payment in response to the directive from the lender.

2. The method as recited in claim 1, wherein the agricultural product comprises grain.

3. The method as recited in claim 1, further comprising transferring the payment via the electronic wallet interface upon verifying availability of user funds.

4. The method as recited in claim 1, further comprising verifying the user of the electronic wallet interface via matching user provided data to the agricultural lien management system.

5. The method as recited in claim 4, further comprising determining a confidence score for the user within the agricultural lien management system.

6. The method as recited in claim 4, further comprising associating the user of the electronic wallet interface with a particular lien.

7. The method as recited in claim 1, wherein associating the user with a particular lien comprises scanning UCC data via the agricultural lien management system.
